(19) United States
(12) Patent Application Publication
(10) Pub. No.: US 2010/0302944 A1
(43) Pub. Date: Dec. 2, 2010

(54) System & method for load spreading

(76) Inventors: Thierry C. Bessis, Naperville, IL (US); Kenneth W. Brent, Aurora, IL (US); Alan Tang, QingDao (CN)

Correspondence Address: Docket Administrator;Alcatel Lucent USA Inc.,, Room 2F-192, 600 Mountain Avenue, Murray Hill, NJ, 07974-0636, US

(21) Appl. No.: 12/455,230

(22) Filed: May 29, 2009

(51) Int. Cl. H04L 12/26

(52) U.S. Cl. 370/235

(57) ABSTRACT

Various method and apparatus are provided directed to load allocation. In one embodiment, a distributor distributes a load to one of a plurality of peer nodes, each peer node having associated thereto a corresponding scalar based on a load factor value, the scalar of the one peer node satisfying a load management condition. The corresponding scalar of the plurality of peer nodes may be tested in a sequentially order until the load management condition is satisfied by the scalar of the one peer nodes. Testing may include threshold testing and begin with the scalar of a last remote peer node to which a most recent prior load was distributed. When the load management condition is satisfied by a scalar, it is decremented based on the load factor value, which may approximate a first number divided by the number of peer nodes in the plurality.

### FIELD OF THE INVENTION

The invention relates to work allocation to processors in an apparatus and in a distributed processing system.

### BACKGROUND INFORMATION

In certain computer apparatuses and systems, a plurality of processors is available for performing the data processing operations necessary to provide a desired functionality. For example, in certain telecommunications switching systems, a plurality of processors are available for performing the data processing operations necessary to control each call in the system. Each of the plurality of processors is able to perform identical call processing functions required to serve such calls so that any new call can be served by any of these processors.

To maximize system capacity and minimize call setup delays in telecommunications switching systems, methods are provided to allocate each new call to an appropriate processor. The allowed load fractions and traffic ratios for the plurality of processors or peer nodes can be calculated according to a variety of methods known to one skilled in the art. For example, average real time work occupancy of each processor can be measured periodically and, based on this occupancy, the fraction of new calls to be allocated to each processor during the next period may be adjusted in such a manner as to attempt to equalize the occupancy of all the processors during that period. Each of the processors may measure their occupancy simultaneously and in synchronism and be polled periodically by a call allocation processor. The call allocation processor may adjust the fraction of new calls to be allocated to each processor during the next period by reducing that fraction for processors whose occupancy exceeds the average, and increasing the fraction for processors whose occupancy is less than the average. In this manner, variations in the amount of processor time required for each call, which can depend, for example in the case of cellular radio, on the number of cell boundaries and switching system boundaries that a mobile traverses in the course of its call, and on the features invoked by the call, can be accounted for in the allocation of load so as to maximize the total system capacity. Given allowed load fractions for the processors, whether calculated as described above or predetermined via another methodology, the call allocation processor can select the appropriate processor to which to distribute the load/traffic.

For example, FIG. 1 is an exemplary illustration of a distribution node configured to distribute load to three peer nodes using a random algorithm. Local distribution node 10 is configured to communicate with remote peer node #1 20, remote peer node #2 22 and remote peer node #3 24. In the illustrated example, remote peer node #1 is to be allocated twenty percent of the load, remote peer node #2 is to be allocated seventy percent of the load and remote peer node #3 is to be allocated ten percent of the load from the local distribution node. That is; the allowed traffic fraction for peer node #1 is 20%, peer node #2 is 70%, and peer node #3 is 10%.

Based on the allocated load percentage, conditions for the distribution of load according to evaluation of a random number are established. According to the random distribution algorithm, each time a local distribution node wishes to distribute a load to one of the remote peer nodes, a random number is generated. The conditions established based on the allocated load percentage are then consulted to determine to which remote peer node the load is to be distributed.

Conditions associated with the distribution of load to each remote peer node are illustrated. According to the example, load will be distributed to remote peer node #1 when a generated random number (R) associated with that particular load is greater than zero, and less than or equal to twenty (R>0 and <=20), since twenty percent of the load is to be directed to remote peer node #1. A load will be distributed to remote peer node #2 when the generated random number associated with that particular load is greater than twenty, and less than or equal to ninety (R>20 and <=90), since seventy percent of the load is to be directed to remote peer node #2. And, a load will be distributed to remote peer node #3 when the generated random number associated with that particular load is greater than ninety, and less than or equal to one hundred (R>90 and <=100) since ten percent of the load is to be directed to remote peer node #3. That is; the comparing condition for node #1 is “0<Allowed Traffic<=20”; for node #2, it is “20<Allowed Traffic<=90”, for node #3, it is “90<Allowed Traffic<=100”.

The distribution of exemplary loads as represented by an associated random number is also illustrated in FIG. 1. For example, loads 8, 1, 19, 14 . . . are distributed to remote peer node #1; loads 45, 57, 33, 69 . . . are distributed to remote peer node #2; and loads 95, 91, 99 . . . are distributed to remote peer node #3. A random number is generated each time a local distribution node wishes to distribute a load to one of the remote peer nodes. The local distribution node then goes through each of the conditions associated with the remote peer nodes to check to which remote node the generated random number is associated in order to select the appropriate remote node for distribution.

### SUMMARY OF THE INFORMATION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to a more detailed description.

Provided are systems, apparatus and techniques for load spreading/distribution in a distributed system. The provided embodiments are directed to load allocation.

In one embodiment, a method comprises distributing a load to one of a plurality of peer nodes, each peer node having associated thereto a corresponding scalar based on a load factor value, the scalar of the one peer node satisfying a load management condition. The method may include receiving a request to distribute the load. The method may also include determining the one of the plurality of peer nodes that satisfies the load management condition.

In an exemplary embodiment, determining the one of the plurality of peer nodes that satisfies the load management condition further includes testing the corresponding scalar of the plurality of peer nodes in a sequentially order until the load management condition is satisfied by the scalar of the one of the plurality of peer nodes. In further embodiments, such testing may begin with the scalar of a last peer node to which a most recent prior load was distributed, the scalar of a next peer node to which a most recent prior load was distributed, or the scalar of a preceding peer node to which a most recent prior load was distributed.

In another embodiment, the load management condition is satisfied when the scalar of the one of the plurality of peer nodes is greater than a threshold. Further, the scalar of the one of the plurality of peer nodes may be decremented based on the load factor value when the load management condition is satisfied. In an embodiment, the load factor value is approximately equal to a first number divided by the number of peer nodes in the plurality.

In a further embodiment, each peer node may have associated thereto an allowable load fraction and the corresponding scalar for each peer node may depend on the corresponding allowable load fraction. The corresponding scalar for each peer node may be initialized based on the corresponding allowable load fraction.

In one embodiment, the method further includes incrementing the corresponding scalar for each peer node based on the corresponding allowable load fraction when the corresponding scalars for the plurality of peer nodes are below a threshold. When the corresponding scalars for the plurality of peer nodes are below a threshold, the scalars are incremented in another embodiment.

The distributing may occur at a distributing node of a distributed processing system. For example, the distributing node may be an IP Resource Controller (IRC). The peer nodes may be Media Gateways (MGW). In an IP Multimedia Subsystem (IMS), the distributing node could be an IP Multimedia Subsystem core network element such as I-CSCF, S-CSCF, BGCF, IBCF, etc. In another exemplary embodiment, the distributing nodes may be Domain Name Servers (DNS servers) with the DNS resolver distributing the loads to the root DNS servers around the world. In embodiments applied to a distributed compiling system, the distributing nodes may be the far end build servers. The distributing nodes may also be the computing nodes in a Distributed Computing System. In one embodiment, the distributing occurs is performed at a first processor and the load distributed to one of a plurality of second processors.

In one embodiment, a method for controlling load spreading is provided that includes distributing a first load to a first peer node of a plurality of peer nodes when the first peer node has associated therewith a corresponding scalar that satisfies a load management condition, the scalar based on a load factor value. The method may further include determining the first peer node based on a plurality of scalars, each scalar corresponding to one of the plurality of peer nodes, wherein the corresponding scalar for the first peer node satisfies the load management condition. The first node may be one of the plurality of peer nodes, each peer node having associated therewith a corresponding scalar.

In one embodiment, the load management condition may be satisfied when the corresponding scalar for the first peer node is greater than a threshold and the corresponding scalar for the first peer node is decremented by the load factor value when the load management condition is satisfied. The corresponding scalar for the first peer node may depend on an allowable load fraction for the first peer node.

In a further embodiment, the method may include incrementing the corresponding scalar for the plurality of peer nodes based on a corresponding allowable load fraction for the plurality of peer nodes when the corresponding scalars for the plurality of the remote peer nodes is below a threshold.

In one embodiment, a distributor is comprises a memory; and a processor, the processor configured to distribute ones of loads to a ones of a plurality of peer nodes, each peer node having associated thereto a corresponding scalar based on a load factor, the processor further configured to distribute a first load to a first of the peer nodes when the corresponding scalar of the first peer node satisfies a load management condition.

Use of a random algorithm for the distribution of load suffers from a variety of drawbacks. For example, the accuracy of that method depends on the random formula. Due to its statistical reliance aspect, the random method is not accurate for low traffic volumes; it can only approach the required distribution for high volume traffic.

In addition, due to the characteristic/s of the random method, each time the local node needs to select a remote node to which to distribute the load, the random method may be required to walk through each and every condition for all of the remote nodes in order to find the appropriate node based on the generated random number. For instance, referring to FIG. 1, if the random number generated for a load is 99, the random methodology must consult the comparing condition for remote node #1, remote node #2 and remote node #3 before determining the appropriate remote node to which to distribute that particular load.

Each time the local node needs to select one remote node, it will need to go through all the comparing conditions to select a proper remote node. Because the transient generated number is random, the random algorithm may be required to traverse all the conditions on each selection. Accordingly, this random algorithm has low efficiency. That is to say, the random method does not have “memory” or context among selections so is not efficient.

Furthermore, the random algorithm is inefficient in handling system growth/de-growth due to the fact that the range of allowed fractions for each node depends on the fraction of other nodes. In other words, the comparing conditions need to be adjusted whenever remote nodes are growed or degrowed in the network.

FIG. 2 is an exemplary illustration of a distribution node configured to distribute load to four peer nodes using a random algorithm. FIG. 2 illustrates the problematic issue of comparing conditions changes when peer nodes are grown or degrown in a system that utilizes the random algorithm for load distribution. Given an initial state with three peer nodes, as illustrated in FIG. 1, when an additional peer node is growed to the system *e.g., peer node #4 26, all the comparing conditions will need to be changed accordingly. In FIG. 2, the allowed traffic fraction for peer node #1 is 15%, peer node #2 is 55%, peer node #3 is 15%, and peer node #4 is 15%.

Conditions associated with the distribution of load to each remote peer node are illustrated. The comparing condition for node #1 is “0<Allowed Traffic<=15”; for node #2, it is “15<Allowed Traffic<=70”, for node #3, it is “70<Allowed Traffic<=85”; and for node #3, it is “85<Allowed Traffic<=100”. According to the example, load 30 will be distributed to remote peer node #1 when a generated random number (R) associated with that particular load is >0 and <=15, since fifteen percent of the load is to be directed to remote peer node #1. A load 32 will be distributed to remote peer node #2 when the generated random number associated with that particular load is >15 and <=70, since fifty-five percent of the load is to be directed to remote peer node #2. A load will be distributed to remote peer node #3 when the generated random number associated with that particular load is >70 and <=85, since fifteen percent of the load is to be directed to remote peer node #3. And, a load will be distributed to remote peer node #4 when the generated random number associated with that particular load is >85 and <=100, since fifteen percent of the load is to be directed to remote peer node #4. As can be understood, all the comparing conditions will need to be changed accordingly when new remote nodes are growed to the system. Likewise, peer node degrowth will cause the same problematic issue of comparing conditions changes.

The exemplary methods, apparatuses and systems in accord with the invention enables increased speed in the selections of peer nodes by utilizing context and memory. In addition, the comparing condition may remain static throughout utilization of a method in accord with the invention, including during peer node growth and degrowth. The comparing condition consulted to determine whether to distribute of particular load to one of a plurality of peer nodes is not required to be modified when peer nodes are grown and degrown.

Reference herein to “one embodiment”, “another embodiment”, “an exemplary embodiment” and “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. Although various embodiments which incorporate the teachings of the present invention have been shown and described in detail herein, those skilled in the art can readily devise many other varied embodiments that still incorporate these teachings.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein

FIG. 1 is an exemplary illustration of a distribution node configured to distribute load to three peer nodes using a random algorithm;

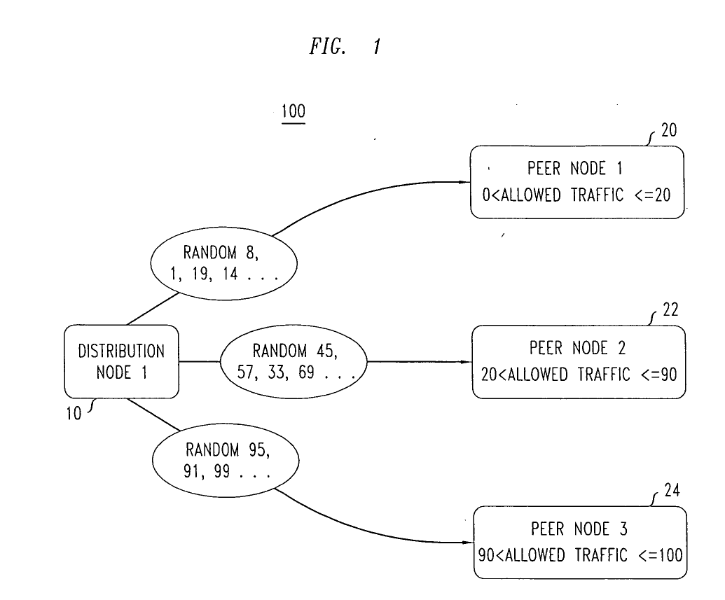

FIG. 2 is an exemplary illustration of a distribution node configured to distribute load to four peer nodes using a random algorithm;

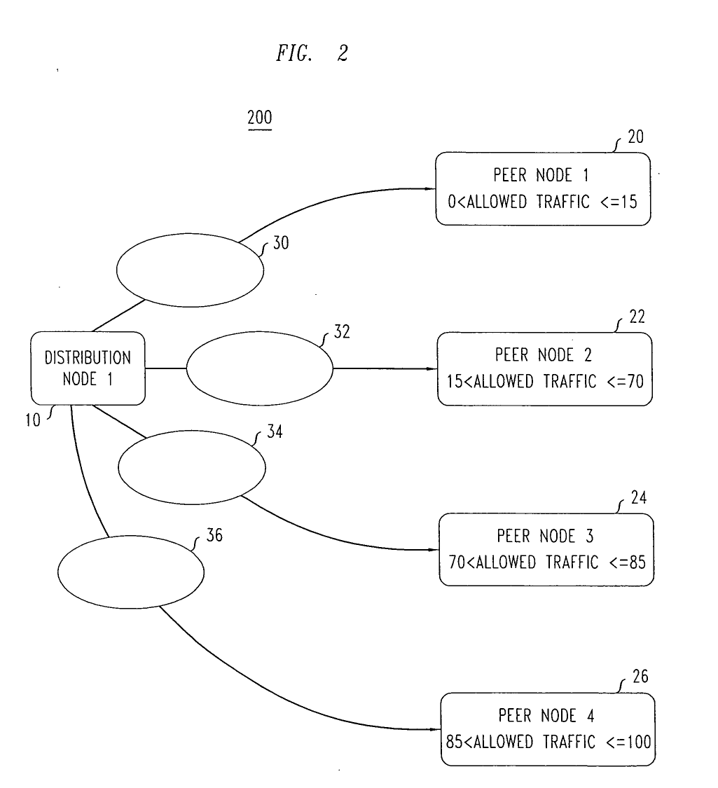

FIG. 3 conceptually illustrates an exemplary method in accordance with the invention, and which may be embodied at distribution node; and

FIG. 4 is an exemplary table illustrating exemplary values for scalars assigned to each of three peer nodes.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Various example embodiments will now be described more fully with reference to the accompanying figures, it being noted that specific structural and functional details disclosed herein are merely representative for purposes of describing example embodiments. Various structures, systems and devices are schematically depicted in the drawings for purposes of explanation only and so as to not obscure the embodiments with details that are well known to those skilled in the art. Nevertheless, the attached drawings are included to describe and explain illustrative examples according to the principles of the present invention. Example embodiments may be embodied in many alternate forms and should not be construed as limited to only the embodiments set forth herein.

The words and phrases used herein should be understood and interpreted to have a meaning consistent with the understanding of those words and phrases by those skilled in the relevant art. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning, such a special definition will be expressly set forth in the specification in a definitional manner that directly and unequivocally provides the special definition for the term or phrase.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein, the term “and” is used in both the conjunctive and disjunctive sense and includes any and all combinations of one or more of the associated listed items. The singular forms “a”, “an” and “the” are intended to include the plural forms as well, unless the context clearly indicates otherwise. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

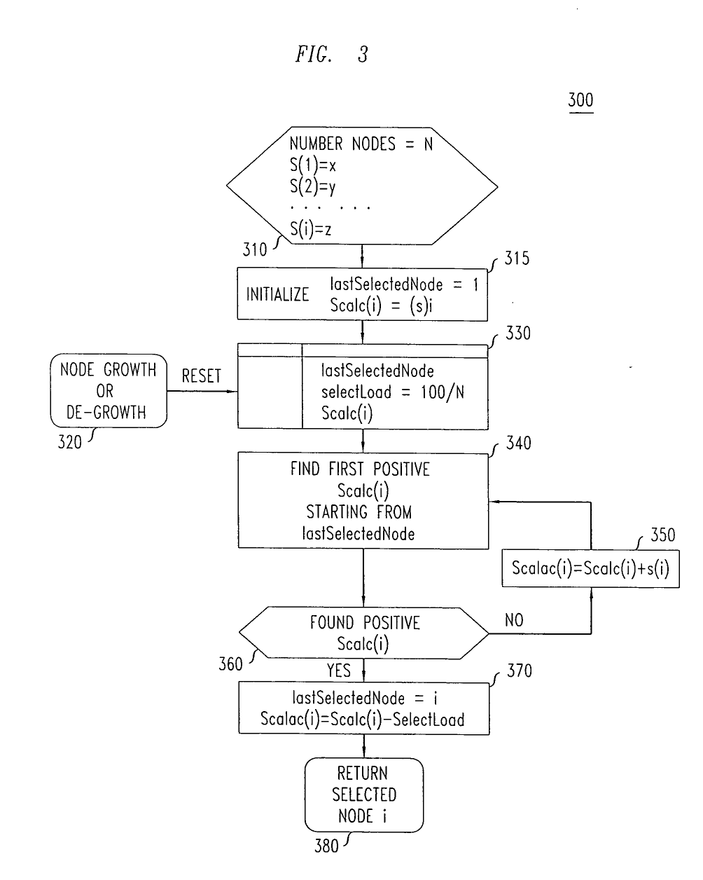

FIG. 3 conceptually illustrates an exemplary method in accordance with the invention, and which may be embodied at distribution node. The exemplary method distributes a load to one of a plurality of peer nodes, each peer node having associated thereto a corresponding scalar based on a load factor value, the scalar of the one peer node satisfying a load management condition. The method may include receiving a request to distribute the load. The distribution node and peer nodes may be co-located, located within a same processor or located within a same functional entity. In other embodiments, the distribution node and peer nodes may be physically separate and distributed entities. For instance, the methodology is applicable to both intra and internetworked nodes.

The exemplary method 300 begins at step 315 wherein a first initialization process is undertaken. There, an indicator of the last selected node is initialized and a scalar associated with a node to be evaluated is initially determined (e.g., lastSelectedNode=1; Scalar(i)=s(i) where i is an integer). The scalar is a quantity or parameter possessing a magnitude. Such initialization facilitates testing the corresponding scalar of the plurality of peer nodes in a sequentially order until the load management condition is satisfied by the scalar of the one of the plurality of peer nodes.

The method may optionally include a step 310 wherein load distribution data is determined. Load distribution data includes the number of peer nodes to which data may be distributed and an allowed traffic ration for each of the peer nodes. For example, the load distribution data predetermined, input by a system operator, and determined automatically based on work time occupancy of the peer nodes. For example, the number of nodes may be set to an N, where N is any integer representing any plural number of nodes. Allowed traffic ration for each of the peer nodes may be determined in a similar fashion. For example, peer node #1 may have an allowed traffic ration of X %, peer node #2 may have an allowed traffic ration of Y %, and peer node #3 may have an allowed traffic ration of Z %. The corresponding scalar for each node is initialized in accord with those percent traffic allocations (S(1)=X, S(2)=Y, and S(3)=Z). The allowable load fraction indicates the percentage of load that is to be assigned to each peer node. Thus, each peer node has associated thereto an allowable load fraction, and wherein the corresponding scalar for each peer node depends on the corresponding allowable load fraction. The corresponding scalar for each peer node is initialized based on the corresponding allowable load fraction

At step 330, a second initialization process is performed. There, a load factor value is determined. The load factor value depends on the number of peer nodes to which load may be distributed. The load factor value is a value that reflects equal percentage distribution of loads to each of the peer nodes. The load factor value is approximately equal to a first number divided by the number of peer nodes in the plurality. For example, if there are three (3) peer nodes in the plurality of nodes and the first number is one hundred (100), the load factor value may be calculated to be thirty-three (100/3≈33). As another example, the first number may be one thousand (1000) and the number of peer nodes may be twenty (20) in which case, the load factor value is fifty (1000/20=50) To account for rounding, the load factor value may be rounding up or down to the nearest integer. While integer values are used herein for ease of understanding, it should be noted that alternative number types may be utilized in other embodiments. For example, floating numbers may be used for the various parameters described to gain more accuracy. For instance, the load factor value could be 100/3=33.3333333 etc. This second initialization process may be undertaken each time a load is to be distributed.

At step 340, it is determined the one of the plurality of peer nodes that satisfies the load management condition. In one embodiment, starting with the scalar for the last selected node, the exemplary method loops through the scalars associated with each peer node in order to determine the first scalar that is above a threshold. For example, the load management condition may be satisfied when the scalar of the one of the plurality of peer nodes is a non-negative number. As another example, the load management condition may be satisfied when the scalar of the one of the plurality of peer nodes is greater than zero. Accordingly, the threshold against which the value of the scalars is tested may be zero, any positive number or any negative number. In addition, the threshold may be modified from time-to-time if so desired.

The exemplary method may traverse the scalars in a sequential order until the load management condition is satisfied. For example, the scalars may be examined in a forward numerical order (e.g., node #1, node #2, . . . node #N), reverse numerical order (e.g., node #N, . . . node #2, node #1) or some other sequential order. In one embodiment, the scalars for the plurality of peer nodes may be examined in an arbitrary or random order.

At step 360 it is determined whether the load management condition was satisfied by the scalar associated with any of the peer nodes. For example, it may be determined whether a positive scalar was found for any of the peer nodes. If a positive scalar was not found, the exemplary method proceeds to step 350, wherein the corresponding scalar for each peer node is incremented based on the corresponding allowable load fraction when the corresponding scalars for the plurality of peer nodes are below a threshold. Thus, when the corresponding scalars for the plurality of peer nodes are below a threshold, the scalars are incremented. In one embodiment, the scalar for each peer node may be incremented based on the corresponding allowable load fraction or may be incremented so as to be reinitialized to a value in accord with the corresponding allowable load fraction. The method then loops back to step 340 to find the first scalar that satisfies the load management condition.

When a scalar that satisfies the load management condition is determined, at step 370 the indicator for the last selected node is update to reflect the node to which the most recent load is to be distributed and the associated scalar for that node is decremented by the load factor value. Thus, the scalar of the one of the plurality of peer nodes that satisfies the load management condition is decremented based on the load factor value.

At step 380, an identifier of the peer node to which to distribute the current load is returned. The method may also then include distributing the load to that node which satisfied the load management condition. In addition, on subsequent attempts to distribute a load to a peer node, testing of the corresponding scalar of the plurality of peer nodes may begin with the scalar of a last peer node to which a most recent prior load was distributed through utilization of the last selected node indicator. It will be recognized that subsequent attempts to distribute a load to a peer node utilizing the described method may begin at step 330.

Peer node growth and de-growth is indicated by step 320. When peer nodes are added or removed, only certain parameters need be reset. Naturally, the number of nodes changes when nodes are grown or de-grown. Such change will modify the load factor value described herein. Further, the Peer node growth and de-growth will typically will result in a change the allowable load fraction for at least two peer nodes. However, after such minor changes, the methods described proceeds without changing any comparing conditions. In other words, the scalar associated with each node continues to be compared to the same threshold to determine whether a particular load is to be distributed to that node

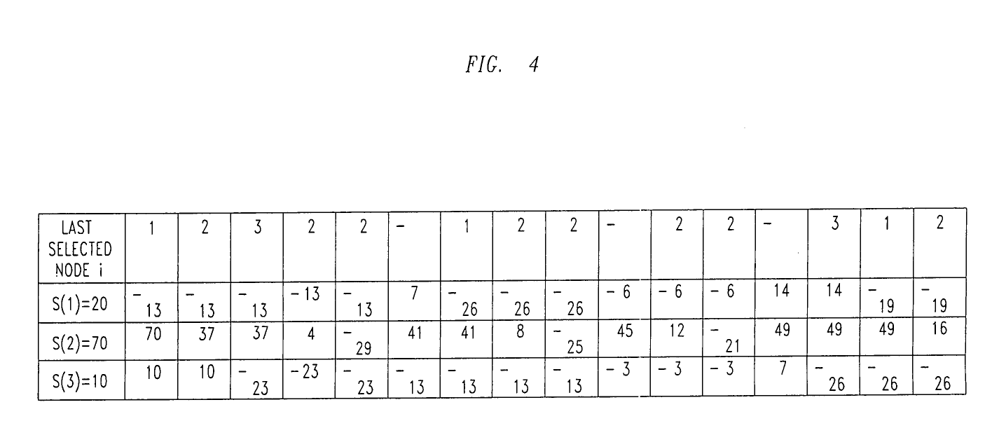

FIG. 4 is an exemplary table illustrating exemplary values for scalars assigned to each of three peer nodes through iterations of an exemplary method according to an embodiment of the invention. For example, the number of peer nodes may be three, with peer node #1 having an allowed traffic ration twenty percent, peer node #1 having an allowed traffic ration seventy percent, and peer node #3 having an allowed traffic ration ten percent (N=3; with S(1)=20%, S(2)=70%, and S(3)=10%). See column 1. The scalar for each peer node is initialized accordingly in a first initialization step. While three (3) peer processing nodes are illustrated as available, the provided method may be applied to any number of remote nodes.

The first row of the table indicates the selected node number to which the current load is to be distributed, and the column gives the scalars for each node including the new scalar for the node that is selected. In a second initialization step, the load factor value is calculated (e.g., SelectLoad=100/3=33).

The exemplary embodiment initializes the following:

lastSelectedNode=1

SelectLoad=100/N

∀i Scalar(i)=S(i)

Each time the distribution node needs to select a peer node to which to distribute a load, the first positive Scalar(i), starting from lastSelectedNode, is determined. i is an integer from 1 to the number of nodes (N) such that Scalar(i) is a scalar associated with node #i.

If a positive scalar is found, lastSelectedNode is updated to i; the Scalar(i) is updated based on the load factor value (e.g., Scalar(i)=Scalar(i)−SelectLoad); and the selected peer node “i” is returned for further processing of the load. For example, the load may then be distributed to the selected peer node “i”. In one embodiment, lastSelectedNode is updated to i+1, so that the determination of the node to which a load is to be distributed begins with the next sequential node to which a most recent prior load was distributed.

Thus, in column 2, node #1 is found to have a positive scalar and so is decremented based on the load factor value (e.g., 20−33=−13). An indicator that the load should be distributed to node #1 is returned so that such action may be accomplished. When a next load is desired to be distributed, in column 3, the scalar associated with node #2 is determined to be positive. Thus, that scalar is decremented based on the load factor value (e.g., 70−33=37) and an indicator that the load should be distributed to node #2 is returned.

For the next load to be distributed, column 4 illustrates the scalar associated with node #3 being the scalar determined to be positive. Thus, that scalar for node #3 is decremented based on the load factor value (e.g., 10−33=−23) and an indicator that the load should be distributed to node #3 is returned. Similarly, column 5 illustrates that the scalar associated with node #2 has been determined to be positive and that scalar being decremented based on the load factor value (e.g., 37−33=4).

When a next load is desired to be distributed, in column 6, the scalar associated with node #2 has been examined and determined to be positive. Thus, that scalar is decremented based on the load factor value (e.g., 4−33=−29) and an indicator that the load should be distributed to node #2 is returned.

If a positive scalar is not found (i.e., all the Scalar(i) terms are negative), the corresponding scalar for each peer node is incremented based on the corresponding allowable load fractions for the each peer node (∀i Scalar(i)=Scalar(i)+S(i)). In column 7, it is determined the corresponding scalar associated with each of nodes is negative. Thus, each scalar is incremented based on the allowable load fraction (e.g., node #1: −13+20=7; node #2 −29+70=41; node #3: −23+10=−13). The method then attempts to determine whether a positive scalar can be found, and proceeds as described in the preceding paragraphs. Accordingly, column 8 illustrates that the scalar associated with node #1 is then determined to be positive. Thus, the scalar for node #1 is decremented based on the load factor value (e.g., 7−33=−26) and an indicator that the load should be distributed to node #1 is returned. The remainder of the exemplary table may be understood in similar fashion.

In one embodiment, the distributing occurs at a distribution node of a distributed processing system. For example, the distributing node may be an IP Resource Controller (IRC). The IRC ensures availability and allocation of required IP resources, such as the bandwidth needed to support video sessions, guaranteeing end-to-end quality for services over a converged IP core network. The peer nodes may also be Media Gateways (MGW).

In an IP Multimedia Subsystem (IMS), the distributing node could be an IP Multimedia Subsystem core network element such as I-CSCF, S-CSCF, BGCF, IBCF, etc. In another exemplary embodiment, the distributing nodes may be Domain Name Servers (DNS servers) with the DNS resolver distributing the loads to the root DNS servers around the world. In embodiments applied to a distributed compiling system, the distributing nodes may be the far end build servers. The distributing nodes may also be the computing nodes in a Distributed Computing System. In one embodiment, the distributing occurs is performed at a first processor and the load distributed to one of a plurality of second processors, the second processors being peer nodes.

The method provided and apparatuses and systems incorporating the method may be utilized any time an optimal distribution, in percentage, to n recipients is desired, and the distribution is discrete (e.g., packetized). For example, the methodology may be embodied in a controller for a conveyor system which distributes packages via conveyors of differing size (capacity) according to a conveyor capacity distribution and may be embodied in a router for routing packets via a variety of paths.

In one embodiment, the distributing occurs is performed at a first processor and the load distributed to one of a plurality of second processors. For example, a distribution node may comprises a memory; and a processor, the processor configured to distribute ones of loads to a ones of a plurality of peer nodes, each peer node having associated thereto a corresponding scalar based on a load factor, the processor further configured to distribute a first load to a first of the peer nodes when the corresponding scalar of the first peer node satisfies a load management condition.

In certain embodiments, the load is autonomously broadcast by the distribution node to the first of the peer nodes to which a load is to be distributed. In other embodiments, the load is multicast to all peer nodes and load/utilization scalars at the peer nodes utilized to determine the appropriate peer node to which the multicast load is to be distributed. In such embodiments, the peer nodes will be provided with appropriate initialization information and information related to node growth and degrowth.

The method functions described above are readily carried out by special or general purpose digital information processing devices acting under appropriate instructions embodied, e.g., in software, firmware, or hardware programming. For example, methodology can be implemented as an ASIC (Application Specific Integrated Circuit) constructed with semiconductor technology. Alternatively, the methodology according to the invention may be implemented with FPGA (Field Programmable Gate Arrays) and other computer hardware. As such, the process steps described herein are intended to be broadly interpreted as being equivalently performed by software, hardware and a combination thereof in various alternative embodiments.

Embodiments according to the exemplary method include one or more of the following advantages:

The comparing conditions for the plurality of nodes are simple and stable. The method need only to compare the value of the scalar for the peer nodes to a single threshold value. For example, the method needs only to compare a scalar with zero to determine if the Scalar(i) is positive.

Peer nodes growth and de-growth is easily taken into account. When remote nodes are added or removed, only some parameters need to be reset while the comparing conditions may remain unchanged

Memory of prior action is taken into account to provide a more effective and efficient determination of the appropriate peer node for load distribution. For example, lastSelectedNode and the Scalar(i) are saved from load distribution iteration to iteration. Such knowledge of prior action permits the calculated results of this exemplary method match well the expected allowed traffic ratios, even when the total number of traffic loads to be distributed is very low. For instance, with three peer node, the calculated “Selections of Node” become approximately the same as the expected “Allowed Traffic” ratios when the total number of executions remains low.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified and all such variations are considered within the scope and spirit of the invention.

What is claimed is:

1. A method comprising:
distributing a load to one of a plurality of peer nodes, each peer node having associated thereto a corresponding scalar based on a load factor value, the scalar of the one peer node satisfying a load management condition.

2. The method of claim 1 further comprising:
receiving a request to distribute the load.

3. The method of claim 1 further comprising:
determining the one of the plurality of peer nodes that satisfies the load management condition.

4. The method of claim 3 wherein determining the one of the plurality of peer nodes that satisfies the load management condition further comprises:
testing the corresponding scalar of the plurality of peer nodes in a sequentially order until the load management condition is satisfied by the scalar of the one of the plurality of peer nodes.

5. The method of claim 3 wherein determining the one of the plurality of peer nodes that satisfies the load management condition further comprises:
testing of the corresponding scalar of the plurality of peer nodes beginning with the scalar of a last peer node to which a most recent prior load was distributed.

6. The method of claim 1 wherein the load management condition is satisfied when the scalar of the one of the plurality of peer nodes is greater than a threshold.

7. The method of claim 1 wherein the scalar of the one of the plurality of peer nodes is decremented based on the load factor value when the load management condition is satisfied.

8. The method of claim 7 wherein the load factor value is approximately equal to a first number divided by the number of peer nodes in the plurality.

9. The method of claim 1, wherein each peer node has associated thereto an allowable load fraction, and wherein the corresponding scalar for each peer node depends on the corresponding allowable load fraction.

10. The method of claim 1, wherein each peer node has associated thereto an allowable load fraction, and wherein the corresponding scalar for each peer node is initialized based on the corresponding allowable load fraction.

11. The method of claim 1, wherein each peer node has associated thereto an allowable load fraction, the method further comprising:
incrementing the corresponding scalar for each peer node based on the corresponding allowable load fraction when the corresponding scalars for the plurality of peer nodes are below a threshold.

12. The method of claim 1 wherein when the corresponding scalars for the plurality of peer nodes are below a threshold, the scalars are incremented.

13. The method of claim 1 wherein the distributing occurs at a distributing node of a distributed processing system.

14. A method for controlling load distribution, the method comprising:
distributing a first load to a first peer node of a plurality of peer nodes when the first peer node has associated therewith a corresponding scalar that satisfies a load management condition, the scalar based on a load factor value.

15. The method of claim 14 further comprising:
determining the first peer node based on a plurality of scalars, each scalar corresponding to one of the plurality of peer nodes, wherein the corresponding scalar for the first peer node satisfies the load management condition

16. The method of claim 14 wherein the first node is one of the plurality of peer nodes, each peer node having associated therewith a corresponding scalar.

17. The method of claim 14 wherein the load management condition is satisfied when the corresponding scalar for the first peer node is greater than a threshold; and wherein the corresponding scalar for the first peer node is decremented by the load factor value when the load management condition is satisfied.

18. The method of claim 14 wherein the corresponding scalar for the first peer node depends on an allowable load fraction for the first peer node.

19. The method of claim 14 further comprising:
incrementing the corresponding scalar for the plurality of peer nodes based on a corresponding allowable load fraction for the plurality of peer nodes when the corresponding scalars for the plurality of the remote peer nodes is below a threshold.

20. A distributor comprising:
a memory; and
a processor, the processor configured to distribute ones of loads to a ones of a plurality of peer nodes, each peer node having associated thereto a corresponding scalar based on a load factor, the processor further configured to distribute a first load to a first of the peer nodes when the corresponding scalar of the first peer node satisfies a load management condition.
